(19) United States
(12) Patent Application Publication
(10) Pub. No.: US 2008/0280166 A1
(43) Pub. Date: Nov. 13, 2008

(54) Solid Oxide Fuel Cell

(75) Inventors: Boris L. Kuzin, Ekaterinburg (RU); Sergey M. Beresnev, Ekaterinburg (RU); Nina M. Bogdanovich, Ekaterinburg (RU); Edhem Kh. Kurumchine, Ekaterinburg (RU); Ana Berta Lopes Correia Tavares, Varennes (CA); Antonio Zaopo, Milano (IT); Yuri A. Dubitsky, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: PERELLI & C.S.P.A., Milano (IT)

(21) Appl. No.: 10/583,935

(22) PCT Filed: Dec. 30, 2003
(86) PCT No.: PCT/EP2003/014984

§ 371 Date: Jul. 24, 2008

(30) Foreign Application Priority Data
Dec. 24, 2003 (EP) PCTEP2003014999

(51) Int. Cl. H01M 8/10; H01M 8/00; B22F 1/00; C22C 29/00

(52) U.S. Cl. 429/13; 429/33; 419/10; 75/230; 419/22

(57) ABSTRACT

Solid oxide fuel cell wherein the anode has a cermet, including a metallic portion and an electrolyte ceramic material portion substantially uniformly interdispersed.

### BACKGROUND OF THE INVENTION

The present invention relates to a solid oxide fuel cell, to a process for the preparation thereof, and to a method for producing energy by means of said solid oxide fuel cell.

### PRIOR ART

As reported, for example, by R. Craciun et al., J. Electrochem. Soc., 146(11) 4019-4022 (1999), solid oxide fuel cells (SOFCs) offer a promising means for producing electricity from chemical energy. The most common anode materials for SOFCs are Ni (nickel) cermets prepared by high temperature calcination of NiO and yttria-stabilized zirconia (YSZ) powders.

Substitution of Ni by Cu (copper) is said to be promising if the problems associated with processing Cu are overcome. Said problems arise from the fact that Cu cermet cannot be produced using the same method usually used for Ni cermet. As reported by R. J. Gorte et al., Adv. Mater., 2000, 12, No. 19, 1465-1469, with Ni-YSZ, the usual method for producing the cermet involves calcining mixed powders of NiO and YSZ to set up channels for ion conduction in the YSZ, then reducing NiO to produce Ni metal and develop porosity. Since densification of YSZ requires heating to at least 1300° C. and Cu₂O melts at 1235° C., it is not possible to prepare Cu cermet using this approach.

That paper describes the preparation of Cu-cermet anodes by adding Cu after preparing a porous layer of YSZ on a dense YSZ electrolyte layer. Cu is added by aqueous impregnation with a concentrated solution of Cu(NO₃)₂, followed by calcination to decompose the nitrate and form the oxide. Reduction of the oxides by H₂ at 800° C. leads to the formation of metallic Cu. YSZ is a cast dual tape with porosity introduced into one of the layers using graphite particles as pore formers. The cell with Cu-YSZ anode exhibits poor performance at 700° C.

G. C. Mather et al., Fuel Cells 2001, 1 (3-4), 233 teach to prepare a CuO-20CGO (gadolinia-doped ceria, Gd_{0.2}—Ce_{0.8}O_{2-δ}) oxide mixture by combustion synthesis of a nitrate mixture (Cu, Ce and Gd) using a 50% excess urea as fuel for yielding powders without undue coarsening. The copper oxide in the resulting oxide mixture is reduced to metal by annealing in a dry 10% H₂-90% N₂ atmosphere in a temperature range of 600-800° C. Cermets with Cu contents from 20 to 50 vol. % are obtained and the combustion of the nitrated component lowers the sintering temperature of the anode. Conductivity measurements on sintered cermet pellets in 10% H₂-90% N₂ indicate that a percolation limit for metallic conductivity is reached at a Cu content of 40 vol. % (≈400 Scm⁻¹ at 600° C.).

As reported by M. B. Joerger et al., 14^{th} International Conference of Solid State Ionics, Jun. 22-27, 2003, Monterey, Calif., U.S.A., page 47, the preparation of Cu containing anodes via a CuO-ceramic mixture route allows an easy control of the metal content, however the grain size of the starting powders has to be adjusted for low temperature processing. In the conclusion it is stated that CuO tends to form large CuO grains before formation of the ceramic framework. The majority of the discussed samples showed a rapid degeneration of conductivity under operating conditions at 550° C., as a consequence of copper coarsening. Only samples consisting of 50 vol. % Cu showed no total rupture of the percolating metal network, and the only one showing a conductivity somewhat constant in time (starting from 230 S/cm to provide 177 S/cm after 60 h at 550° C.) is that containing 50 vol. % of Cu obtained from CuO with a surface area of 18.6 m²/g and CGO (Gd_{0.1}Ce_{0.9}O_{1.95}) with a surface area of 35.8 m²/g. A homogenization on a nano-scale is said necessary for the starting powders to improve thermal stability.

E. Ramirez-Cabrera et al., Fifth European SOFC Forum, Proceedings vol. 1, edited by Joep Huijmans, page 531, 2002 relates to the preparation of Cu-CGO cermets (50 and 65 wt % Cu) from mixtures of CGO (Gd_{0.1}—Ce_{0.9}O_{1.95}) and either CuO or Cu₂O powders. The anode is produced by applying a slurry onto the surface of a dense CGO electrolyte pellet, and then sintering in air at 800° C. or 1000° C. The pellets is then reduced in hydrogen atmosphere. The paper is silent about characterization data of the anode structure, but electronic conductivity in hydrogen atmosphere is measured to be of about 3000 S/cm at 700° C.

As known, the electrical properties of composite materials depend mainly on microstructural properties, such as porosity, distribution of the metal phase, size of the grains and degree of contact between metal grains (J. Macek and M. Manri\check{s}ek, Fizika A 4, 1995, 2, 413-422).

Fine particle size and pore size are known to improve the extension of the reactive sites, thus the performance, however could lead to transportation limitations for the fuel supply. In addition, an increase of the metal content provide a better electronic conductivity, but metal having melting point lower than the sintering temperature (1200° C.-1300° C.) tend to agglomerate and provide heterogeneous structures when present in the cermet in wt % similar or higher than that of the ceramic portion. M. B. Joerger et al., Proc. of the 5^{th} European Solid Oxide Fuel Cell Forum, Lucerne, CH, July 2002, edited by Joep Huijmans, page 475 report that samples with high copper content (60 wt % and 73 wt %) showed a rapid degradation of the conductivity (3%/h).

### PROBLEM UNDERLYING THE INVENTION

The Applicant has faced the problem of providing a SOFC having good electric (electronic plus ionic) conductivity at low temperature, e.g. 600° C.-800° C., and long-lasting performances (structural and redox stability), desirable for any scale applications.

For attaining these goals an intimate distribution of the metallic and ceramic phases in the anode cermet of the SOFC is desirable, together with a metal content higher than the ceramic content.

### SUMMARY OF THE INVENTION

Applicant found that the problem could be solved by providing a SOFC with an anode comprising a cermet wherein the metallic and ceramic portions are uniformly interdispersed and provide a structure with a low surface area.

The metallic portion is present in a amount higher than 50 wt %, without yielding coarsening phenomena and thus assuring thermal and in-time stability of the percolating metal network.

Under these conditions remarkable electrical characteristics (electronic+ionic conductivities) are obtained.

The present invention relates to a solid oxide fuel cell including a cathode, an anode and at least one electrolyte membrane disposed between said anode and said cathode, wherein said anode comprises a cermet including a metallic portion and an electrolyte ceramic material portion, said portions being substantially uniformly interdispersed, said metallic portion having a melting point equal to or lower than 1200° C.; said cermet having a metal content higher than 50 wt %, and a specific surface area equal to or lower than 5 m²/g.

In the present description and claims as “substantially uniformly interdispersed” is meant that the portions of the cermet are intimately admixed in the entire volume of the cermet.

The metallic portion can be selected from a single metal such as copper, aluminum, gold, praseodymium, ytterbium, cerium, and alloys comprising one or more of these metals together. Preferably the metallic portion is copper.

Preferably the metallic portion has a melting point higher than 500° C.

Preferably, the metal content in a cermet suitable for the invention ranges between 60 wt % and 90 wt %.

Preferably, the cermet suitable for the anode of the solid oxide fuel cell according to the invention has a specific surface area equal to or lower than 2 m²/g.

Advantageously, the porosity of the cermet is equal to or higher than 40%.

Preferably the electrolyte ceramic material portion has a specific conductivity equal to or higher than 0.01 S/cm at 650° C. For example, it is doped ceria or La₁₋ₓSrₓGa_{1-y}MgyO_{3-δ} wherein x and y are comprised between 0 and 0.7 and δ is from stoichiometry. Preferably, the ceria is doped with gadolinia (gadolinium oxide) or samaria (samarium oxide).

Alternatively, the ceramic material of the SOFC of the invention is yttria-stabilized zirconia (YSZ).

According to an embodiment of the invention, a first type of cathode for the solid oxide fuel cell of the invention comprises a metal such as platinum, silver or gold or mixtures thereof, and an oxide of a rare earth element, such as praseodymium oxide.

According to another embodiment of the invention, a second type of cathode comprises a ceramic selected from
La₁₋ₓSrₓMnO_{3-δ}, wherein x and y are independently equal to a value comprised between 0 and 1, extremes included and δ is from stoichiometry; and
La₁₋ₓSrₓCo_{1-y}Fe_{y}O_{3-δ}, wherein x and y are independently equal to a value comprised between 0 and 1, extremes included and δ is from stoichiometry.

Said second type of cathode can further comprise doped ceria.

According to a further embodiment of the invention, a third type of cathode comprises a combination of the materials above mentioned for the cathodes of the first and second type.

The electrolyte membrane of the SOFC of the invention can be selected from the materials listed above in connection with the electrolyte ceramic material portion of the cermet.

In another aspect, the present invention relates to a method for producing energy comprising the steps of:

a) feeding at least one fuel into an anode side of a solid oxide fuel cell comprising
an anode including a cermet comprising a metallic portion and an electrolyte ceramic material portion, said portions being substantially uniformly interdispersed, said metallic portion having a melting point equal to or lower than 1200° C.; said cermet having a metal content higher than 50 wt %, and a specific surface area equal to or lower than 5 m²/g;
a cathode, and
at least one electrolyte membrane disposed between said anode and said cathode;
   b) feeding an oxidant into a cathode side of said solid oxide fuel cell; and
   c) oxidizing said at least one fuel in said solid oxide fuel cell, resulting in production of energy.

A fuel suitable for the present invention can be selected from hydrogen; an alcohol such as methanol, ethanol, propanol; a hydrocarbon in gaseous form such as methane, ethane, butene; carbon dioxide, carbon monoxide, natural gas, reformed natural gas, biogas, syngas and mixture thereof, in the presence of water (steam fuel); or an hydrocarbon in liquid form, e.g. diesel, toluene, kerosene, jet fuels (JP-4, JP-5, JP-8, etc). Preferably the fuel is hydrogen.

Advantageously, the solid oxide fuel cell of the invention operates at a temperature ranging between about 400° C. and about 800° C., more preferably between about 500° C. and about 700° C.

The solid oxide fuel cell can be prepared with methods known in the art. Advantageously it is prepared by the following process.

In a further aspect, the present invention relates to a process for preparing a solid oxide fuel cell including a cathode, an anode and at least one electrolyte membrane disposed between said anode and said cathode, wherein said anode comprises a cermet including a metallic portion and an electrolyte ceramic material portion; said process comprising the steps of:
providing the cathode;
providing the at least one electrolyte membrane; and
providing the anode
   wherein the step of providing the anode includes the steps of:
a) providing a precursor of the metallic portion, said precursor having a particle size ranging between 0.2 μm and 5 μm;
b) providing the electrolyte ceramic material having a particle size ranging between 1 μm and 10 μm;
c) mixing said precursor and said ceramic material to provide a starting mixture;
d) heating and grinding said starting mixture in the presence of at least one first dispersant;
e) adding at least one binder and at least one second dispersant to the starting mixture from step d) to give a slurry;
f) thermally treating the slurry to provide a pre-cermet;
g) reducing the pre-cermet to provide the cermet.

Unless otherwise indicated, in the present description and claims as “particle size” is intended the average particle size determined by physical separation methods, for example by sedimentography, as shown hereinbelow.

According to an embodiment of the invention, the slurry resulting from step e) is applied on the electrolyte membrane.

Preferably the precursor of the metallic portion is an oxide of the metals already listed above. For example, in the case of copper the oxide is Cu₂O or CuO, the latter being preferred.

Preferably said precursor has a particle size ranging between 1 and 3 μm.

Preferably the ceramic material has a particle size ranging between 2 and 5 μm.

Advantageously, step d) is effected more than one time.

The first dispersant is a solvent or a solvent mixture. Preferably it is selected from polar organic solvents, such as alcohols, polyols, esters, ketones, ethers, amides, optionally halogenated aromatic solvents such as benzene, chlorobenzene, dichlorobenzene, xylene and toluene, halogenated solvents such as chloroform and dichloroethane, or mixtures thereof. It ensures homogeneity to the starting mixture. Examples are provided in Table 1.

The second dispersant can be the same or different from the first dispersant.

Advantageously, the binder is soluble in the second dispersant. Preferably it is selected from polymeric compounds containing polar groups such as polyvinylbutyral, nitrocellulose, polybutyl methacrylate, colophony, ethyl cellulose. Examples of mixtures binder/second dispersant are provided in Table 1.

TABLE 1

| Binder | Dispersant |
|---|---|
| Polyvinylbutyral | ethanol |
| | ethanol + benzene |
| | ethanol + acetone + butyl alcohol |
| | ethanol + isopropanol + monomethyl ether |
| | ethylene glycol |
| | isopropanol |
| | isopropanol + ethyl acetate + sebacic acid |
| | dibutyl ether |
| Nitrocellulose | isoamylacetate + tetrahydrofurane |
| Polybutyl methacrylate | ethyl acetate |
| | butyl acetate |
| | acetone + butanol |
| | isopropanol + isoamylacetate + ethyl acetate |
| Colophony | ethanol + dichlorobenzene |
| Ethyl cellulose | ethyleneglycol monoethyl ether + p-xylene |

Preferred binder is polyvinylbutyral. Preferred first and second dispersants are ethanol and isopropanol.

Advantageously, step f) is carried out at a temperature ranging between about 700° C. and about 1100° C., more preferably between about 900° C. and about 1000° C.

The reduction step g) converts the metal oxide of the pre-cermet into metal. Preferably this step is carried out at a temperature ranging between about 300° C. and about 800° C., more preferably between about 400° C. and about 600° C.

Hydrogen is a preferred reducing agent. Advantageously, it is introduced in the reduction environment, for example an oven, which has been previously conditioned with an inert gas, such as argon. Advantageously, hydrogen contains from 1 vol. % to 10 vol. % of water, preferably from 2 vol. % to 5 vol. %.

In another further aspect the present invention relates to a cermet including a metallic portion and an electrolyte ceramic material portion, said portions being substantially uniformly interdispersed, said metallic portion having a melting point equal to or lower than 1200° C.; said cermet having a metal content higher than 50 wt %, and a specific surface area equal to or lower than 5 m²/g.

### BRIEF DESCRIPTION OF THE DRAWINGS

The invention will be further illustrated hereinafter with reference to the following examples and figures, wherein

FIG. 1 schematically illustrates a fuel cell power system;

FIG. 2 show the variation of the electric resistance upon temperature of a Cu-SDC anode according to the invention;

FIGS. 3a and 3b are micrographs of a Cu-SDC anode in (a) secondary electron emission and (b) backscattering modes;

FIG. 4 show the anodic polarization of Cu-SDC anodes in humid H₂/air fuel cell prepared in examples 1 (□) and 2 (Δ).

FIG. 5 shows the experimental set-up of example 1, G.

### DETAILED DESCRIPTION OF THE PREFERRED EMBODIMENTS

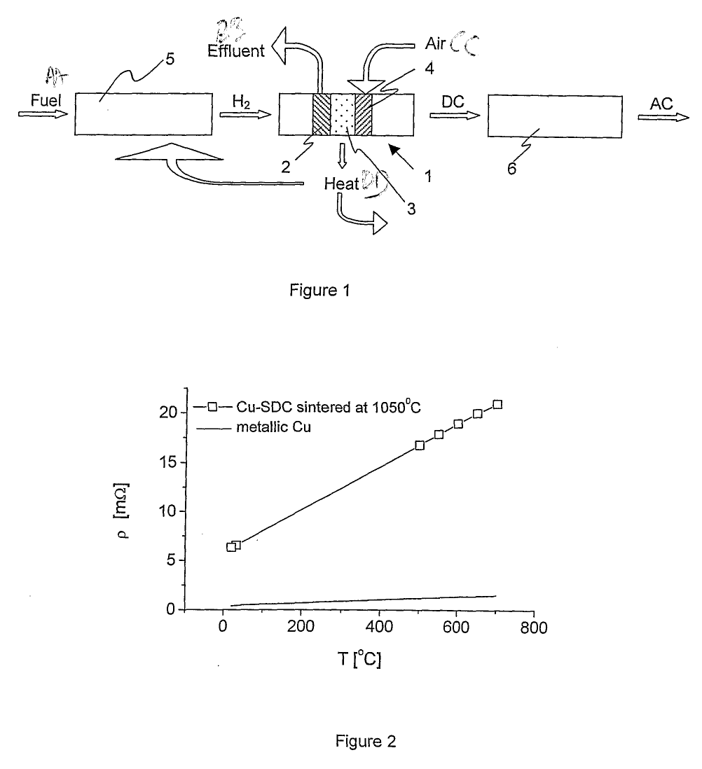

FIG. 1 schematically illustrate a solid oxide fuel cell power systems.

The solid oxide fuel cell (1) comprises an anode (2), a cathode (4) and an electrolyte membrane (3) disposed between them. A fuel, generally a hydrocarbon, is fed to be converted into hydrogen as described, e.g., in “Fuel Cell Handbook”, sixth edition, U.S. Dept. of Energy, 2002. Hydrogen is fed to the anode side of the solid oxide fuel cell (1). Cathode (4) is fed with air.

The fuel cell (1) produces energy in form of heat and electric power. The heat can be used in a bottoming cycle or conveyed to the fuel reformer (5). The electric power is produced as direct current (DC) and may be exploited as such, for example in telecommunication systems, or converted into alternate current (AC) via a power conditioner (6).

From anode (2) an effluent flows which can be composed by unreacted fuel and/or reaction product/s, for example water and/or carbon dioxide

### Example 1

### Preparation and Characterisation of Cu-SDC Cermet Anode (54 wt % Cu, 46 wt % SDC)

### A. Powder Mixture

Cu₂O powder (“analytically pure” grade, >99.5%) was ground in the drum of a “sand” planetary mill with jasper balls using isopropanol as dispersant. The drum was charged with 50 g of the powder oxide, 150 g of balls, and 45 ml of isopropanol. The procedure was carried out for 30 minutes at a drum speed of 110 rpm.

After the dispersant was removed in oven at 100° C., the specific surface area (S) of the ground powder (determined by low-temperature adsorption of nitrogen in a Sorpty-1750 device, Carlo Erba, Italy) and the average particle size (d) (determined by CP-2 centrifugal sedimentographer, Shimadzu, Japan) were measured and found to be S_{Cu}_{₂}_{O}=1.7 m²/g and d_{Cu}_{₂}_{O}=1.8 μm, with a normal particle size distribution from 0 to 2.1 μm.

The ground Cu₂O and Ce_{0.8}Sm_{0.2}O_{1.9} (samaria-doped ceria, SDC) powder (S_{SDC}=1.9 m²/g and d_{SDC}=3.3 μm) were mixed together in a planetary mill with jasper balls in the presence of isopropanol. The charge of the drum included 25 g of the mixture 72.4 wt % Cu₂O+27.6 wt % SDC (18.1 g Cu₂O and 6.9 g SDC), 50 g of balls and 25 ml of iso-propanol. The procedure was carried out for 50 minutes at a speed of 80 rpm, and for 10 minutes at 110 rpm. The dispersant was removed in oven at 100° C., and the Cu₂O-SDC mixture added with a 5 wt % aqueous solution of polyvinyl alcohol (PVA) as binder (10% of the powder mass). Pellets 20 mm in diameter were prepared by semi-dry compaction method at a specific pressure of about 30 MPa.

A heat treatment was performed at 800° C. with a 1.5 hour isothermal holding time and air blasting. The pellets were heated and cooled at a rate of 250° C./hour. After the heat treatment, the pellets changed color from brown to black. The diameter shrinkage and the geometrical density of the sintered pellets were 1.7% and 4.05 g/cm³ respectively.

The pellets were broken in a jasper mortar to obtain grains≦1.25 mm in size. The coarse-grain powder was ground in a “sand” planetary mill with jasper balls in the presence of isopropyl alcohol. The charge of the mill drum did not exceed ⅔ of their volume. The powder/dispersant ratio was maintained at ˜1:0.95. The grinding conditions were: powder/balls ratio of 1:3, n (grinding speed)=110 rpm, grinding time 45 min. An average surface area S=2.9 m²/g and average particle size (d)=2.7 μm were measured for the resulting powder. The fine powder was used to prepare a slurry.

### B. Slurry

The powder mixture of A. was ground in the drum of a “sand” planetary mill with jasper balls. Polyvinyl butyral (PVB) was used as binder and ethanol as the dispersant. The charge included 20 g of the powder mixture, 8 ml of 5 wt % solution of PVB in ethanol, and 15 ml of ethyl alcohol. Four jasper balls, 14 mm in diameter, were put per 20 g of the powder. The charge was mixed for 30 min at a speed of 80 rpm. The resulting slurry was poured into a vessel outfitted with a tight cover to prevent evaporation of the dispersant.

### C. Pre-Cermet.

The slurry of B. was brushed onto an SDC electrolyte membrane (1.82 mm-thick) while stirring. An amount of 16±4 mg/cm² (corresponding to a thickness of 65±5 μm) of “raw” pre-cermet was applied by three brushings with intermediate drying in a warm air jet.

The pre-cermet/electrolyte membrane assembly was then heated in air at 1050° C. under the following conditions: heating at a rate of 200° C./hour in the interval from 20 to 500° C. and at a rate of 250° C./hour in the interval from 500° C. to the experimental temperature. The pre-cermet/electrolyte membrane assembly was kept under isothermal conditions for 2 hours at the final temperature, then cooled at a rate 200° C./hour.

The final thickness of the pre-cermet layer in the pre-cermet/electrolyte membrane assembly was 42 μm and the thickness shrinkage was 38.7% pointing for a good sintering of the pre-cermet structure.

The density of the “raw” and heat treated pre-cermet layer accounted for 45% and 64% of the design density, respectively. So, the open porosity of the heat treated pre-cermet before reduction was ˜36%.

The porosity value was also evaluated by mercury porosimetry. Heat-treated pre-cermet material was deposited on ten plates of SDC electrolyte to a total mass of 0.448 g. The experiments were carried out on PA-3M mercury porosimetric installation, and the volume normalized for 1 g of pre-cermet material was 0.0776 cm³. The volume porosity was then calculated from the following equation:

$$P = \frac{0.0776}{( 1 / ( {m}_{{CuO}_{x}} \times {d}_{{CuO}_{x}} + {m}_{SDC} \times {d}_{SDC} ) + 0.0776} \qquad ( 1 )$$

where m_{CuOx} and m_{SDC} indicate the relative weight amount of the phases in the pre-cermet, and d_{CuOx} and d_{SDC} the specific densities of Cu₂O (6 g/cm³) and SDC (7.13 g/cm³) phases.

The measured volume porosity was 34±3%, which is in agreement with the porosity estimated from mass and geometric values. The average size of the pores was seen to be 1 μm.

### D. Reduction of the Pre-Cermet to Cermet.

After cooling to room temperature, the pre-cermet of the pre-cermet/electrolyte membrane assembly of C. was reduced at a temperature of 500° C. (at a rate of 200° C./hour). The oven was conditioned with argon (3 vol. % H₂O), then hydrogen (3 vol. % H₂O) was introduced to replace argon and kept for 40 min.

### E. Morphological Characterisation of the Cu-SDC Cermet

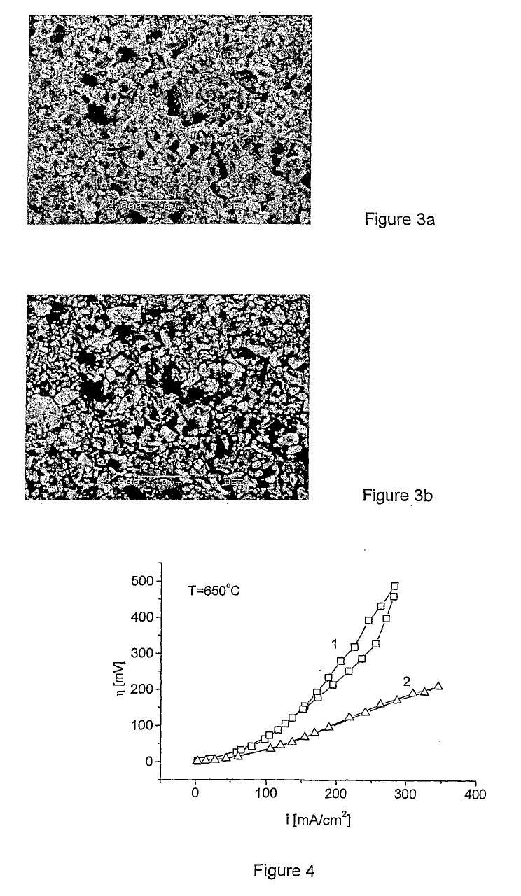

The characterisation was effected using a scanning electron microscope (JSM-5900LV). FIGS. 3a and 3b are two micrographs of the outer surface of the cermet, respectively in secondary electron emission mode (FIG. 3a) and in backscattering mode (FIG. 3b). From these two pictures it can be seen that the prepared cermet has a porous structure where both phases (Cu and SDC) are intimately mixed and homogeneously distributed.

As metallic copper forms an amalgam with mercury, the above described method cannot be used to determine the cermet porosity after reduction. Thus, the porosity of the cermet was calculated considering the following:
a) the volume of the cermet does not changes with the reduction process (V_{pre-cermet}(ox)=V_{cermet}(red))
b) the volume of the SDC electrolyte phase does not changes with the reduction process (V_{SDC}(ox)=V_{SDC}(red))
c) the variation in cermet porosity upon reduction is due to the variation of volume of copper containing phases, and the following relation (2) can be applied:

$$\begin{matrix}Δ V = {V}_{{CuO}_{x}} - {V}_{Cu} \\ = \frac{{m}_{CuO x}}{{d}_{CuO x}} - \frac{{m}_{Cu}}{{d}_{Cu}} \\ = {V}_{CuO x} ( 1 - ( \frac{{d}_{{CuO}_{x}}}{{d}_{Cu}} ) + ( \frac{Δ m}{{d}_{Cu} \cdot {V}_{CuO x}} ) )\end{matrix} \qquad ( 2 )$$

where Dm is the mass difference between the copper and copper oxide, and d_{CuOx} and d_{Cu} are, respectively the density of copper oxide (6 g/cm³ for Cu₂O) and metallic copper (8.9 g/cm³). For the present example DV=0.0532 cm³.

Considering 1 g of oxidized pre-cermet (the pre-cermet), its volume V_{pre-cermet}(ox) is given by:

$$\begin{matrix}{V}_{pre \text{-} cermet} ( ox ) = {V}_{SDC} ( ox ) + {V}_{CuO x} ( ox ) + {V}_{pore} ( ox ) & ( 3 ) \\ {V}_{pre \text{-} cermet} ( ox ) = \frac{{m}_{SDC} ( ox )}{{d}_{SDC} ( ox )} + \frac{{m}_{CuO x} ( ox )}{{d}_{CuO x} ( ox )} + {V}_{pore} ( ox ) & ( 4 )\end{matrix}$$

or
where m_{SDC} and m_{CuOx} are the mass of both phases in the pre-cermet. Being Vₚₒᵣₑ(ox)=0.36V_{cermet}(ox) (from porosimetry measurements), equation (4) can be rewritten as:

$$( 1 - 0.36 ) {V}_{pre \text{-} cermet} ( ox ) = \frac{{m}_{SDC} ( ox )}{{d}_{SDC} ( ox )} + \frac{{m}_{CuO x} ( ox )}{{d}_{CuO x} ( ox )} \qquad ( 5 )$$

and the calculated value for V_{pre-cermet}(ox) is 0.249 cm³.

As the porosity volume of the reduced cermet, Vₚₒᵣₑ(red) is given by:

Vₚₒᵣₑ(red)=Vₚₒᵣₑ(ox)+ΔV (6)

and equal to 0.143 cm³, the final porosity of the cermet Vₚₒᵣₑ(red)/V_{cermet}(red) was of 55%.

The specific surface area was determined by the nitrogen BET method (Sorpty 1750, Carlo Erba Strumentazione, Italy) and resulted to be 1.6 m²/g.

### F. Measurement of the Electrical Resistance of the Cu-SDC Cermet Anode.

The layer resistance (measured along the major layer axis) of the cermet anode was measured by dc four-probe method using an EC-1286 device (Solartron Schlumberger). The cermet anode had a surface of 1×1 cm² and was 42 μm-thick. Current and potential probes were made of platinum wire.

The following procedure was used. After reduction of the pre-cermet layer to cermet, the sample was further heated in hydrogen (3 vol. % H₂O) up to 700° C. at a rate of 200° C./hour. The temperature was maintained for 2 hours, then sequential measurements of resistance were done and the stability of the cermet anode was ascertained. The sample was cooled to 500° C. by steps of 50° C. at a rate of 100° C./hour and step time of 10 min, and its resistance was measured at each grade. Finally, the sample was cooled at a rate of 200° C./hour to room temperature and its resistance was measured again.

The results are shown in FIG. 2. The cermet anode has a metallic behavior with a resistance increasing with temperature. This reads for a uniform distribution of the metallic phase through the cermet anode.

The electric resistance longitudinally along the cermet anode changes between 6.3 mΩ and 21.0 mΩ at a temperature from 20 to 700° C. (as from Table 2). The specific electrical conductivity along the anodes is 11905 Scm⁻¹ and this value confirms that the electric characteristics of the cermet anode are better than those of previously disclosed cermet anode.

### G. Electrochemical Measurements in Fuel Cell Under H₂/Air.

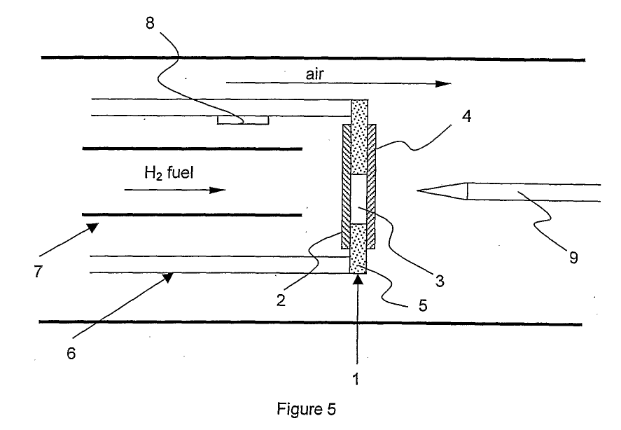

A three-electrode cell (1) as from FIG. 5 was used. The cell comprised a cermet anode (2) as from the present examples, an electrolyte membrane (3) of Ce_{0.8}Sm_{0.2}O_{1.9} (samaria-doped ceria, SDC), and a cathode (4) of Pt+PrOₓ. Anode (2) and electrolyte membrane (3) were a disk-shaped anode/electrolyte membrane assembly (Ø=12 mm) as prepared in the present example. A fine Pt+PrOₓ paste was painted as cathode (4) on the surface of the electrolyte membrane (3) opposite to that in contact with the anode (2) (IHTE RAS, SU invention certificate No. 1.786.965). Each of anode (2) and cathode (4) had an area of about 0.3 cm². A reference electrode (5) was made of a platinum coil on the circumference of the electrolyte membrane (3). The three-electrode cell was pressed by a spring load against the rim of a zirconium dioxide tube (6).

Hydrogen fuel gas (98 vol. % H₂+3 vol. % H₂O, V_{H}_{₂}˜2-5 l/hour) was fed to the anode side through an alumina tube (7) positioned inside the zirconium dioxide tube (6). The cathode side was blown with air (v=6 l/hour). The composition of the combusted cermet anode was determined by means of a solid electrolyte oxygen sensor (8). The cell temperature was measured by a chromel-alumel thermocouple (9).

The overvoltage of the electrodes and the ohmic voltage drop in the electrolyte were determined under stationary conditions (galvanostatic mode) by the current interruption method. The length of the current interruption edge did not exceed 0.3 μs. The off-current state time of the cell was ˜0.3 ms (millisecond). The relative duration of the cut-off pulses (off/on) was ≦ 1/1540.

The measuring set-up included the following instruments:
universal digital voltmeter type B7-39 (0.02% accuracy class);
universal digital oscillograph type C9-8 (1.5% accuracy class);
dc power source type VIP-009;
relay switch unit type RSD-725;
programmed temperature controller type TP-403;
IBM PC 286 AT personal computer;
gas flow-rate regulator type SRG-23.

The instruments and the computer communicated via a COP interface bus (IEEE-488).

The following measurement procedure was used. Hydrogen (3 vol. % H₂O) was flown at 2 l/hour and the cell heated to a temperature of 700° C. at a rate of 200° C./hour. The cell was allowed to stand for 0.5 hour before its polarization characteristics were measured. The measurements were made between 700° C. and 500° C., decreasing temperature. The measurements were repeated at 700° C., and the stability of the cell was ascertained. FIG. 4 presents the recorded polarization curve obtained at 650° C. This anode is able to oxidize H₂ under fuel cell conditions at the working temperature, and for an anodic overpotential of 50 mV a current intensity of 70 mA was measured.

### Example 2

### Preparation and Characterisation of a Cu-SDC Cermet Anode (70 Wt % Cu, 30 Wt % SDC)

The same preparation procedure as described in example 1 was applied using CuO in the place of Cu₂O and the following amount of starting materials: CuO (18.7 g) and SDC (10). The ground CuO had a specific surface area (S_{CuO}) of 0.9 m²/g and an average particle size (d_{CuO}) of 3.4 μm at a normal particle size distribution from 0 to 20 μm. The resulting mixture was prepared as described in example 1, and an average surface area S=3.3 m²/g and average particle size (d)=3.3 μm were measured.

The same amount of slurry (16±4 mg/cm²) was deposited on a SDC electrolyte, and after the heat treatment at 1050° C. the final thickness of the pre-cermet was 39 mm; the thickness shrinkage was 33.7% indicating a good sintering of electrode structure.

The density of the applied slurry and pre-cermet accounted for 45% and 56% of the design density respectively. The open porosity of the pre-cermet before reduction to cermet was 44%, and that of the cermet was 60%. The specific surface area of the cermet was 1.81 m²/g.

The electrical resistance along the cermet anode and the specific electric conductivity were measured according to example 1. The results are set forth in Table 2 and show that the electric characteristics of the cermet anode are better than those of previously disclosed cermet anode.

TABLE 2
Electrical resistance and specific conductivity
along Cu—SDC cermet anode

| | | | | | Specific |
|---|---|---|---|---|---|
| | | | Resistance | Resistance | conductivity |
| | Cu | | R(20° C.)/ | R(700° C.)/ | σ(700° C.)/ |
| Example | precursor | l/μm | mΩ | mΩ | Scm⁻¹ |
| 1 | Cu₂O | 42 | 6.3 | 21.0 | 11905 |
| 2 | CuO | 39 | 5.0 | 17.1 | 14995 |

Scanning electron microscopy of the anode suitable for the invention confirmed the formation of a porous structure with both phases (Cu and SDC) intimately mixed and uniformly distributed inside.

FIG. 4 shows anodic polarization curves at 650° C. for the cermet anodes of example 1 and 2. Relative high current densities are obtained with low anodic overpotentials, as a consequence of the high conductivities and porosity of the anodes.

1-39. (canceled)

40. A solid oxide fuel cell comprising a cathode, an anode and at least one electrolyte membrane disposed between said anode and said cathode, wherein said anode comprises a cermet comprising a metallic portion and an electrolyte ceramic material portion, said portions being substantially uniformly interdispersed, said metallic portion having a melting point equal to or lower than 1200° C.; said cermet having a metal content higher than 50 wt %, and a specific surface area equal to or lower than 5 m²/g.

41. The solid oxide fuel cell according to claim 40, wherein the metallic portion is selected from a single metal selected from copper, aluminum, gold, praseodymium, ytterbium, cerium, and alloys comprising one or more thereof.

42. The solid oxide fuel cell according to claim 41, wherein the metallic portion is copper.

43. The solid oxide fuel cell according to claim 40, wherein the metallic portion has a melting point higher than 500° C.

44. The solid oxide fuel cell according to claim 40, wherein the metal content is 60 wt % to 90 wt %.

45. The solid oxide fuel cell according to claim 40, wherein the cermet has a specific surface area equal to or lower than 2 m²/g.

46. The solid oxide fuel cell according to claim 40, wherein the cermet has a porosity equal to or higher than 40%.

47. The solid oxide fuel cell according to claim 40, wherein the ceramic material has a specific conductivity equal to or higher than 0.01 S/cm at 650®C.

48. The solid oxide fuel cell according to claim 47, wherein the ceramic material is selected from doped ceria and La₁₋ₓSrₓGa_{1-y}Mg_{y}O_{3-δ} wherein x and y are 0 to 0.7 and δ is from stoichiometry.

49. The solid oxide fuel cell according to claim 48, wherein ceria is doped with gadolinia or samaria.

50. The solid oxide fuel cell according to claim 40, wherein the ceramic material is yttria-stabilized zirconia.

51. The solid oxide fuel cell according to claim 40, wherein the cathode comprises a metal selected from platinum, silver, gold and mixtures thereof, and an oxide of a rare earth element.

52. The solid oxide fuel cell according to claim 40, wherein the cathode comprises a ceramic selected from
La₁₋ₓSrₓMnO_{3-δ}, wherein x and y are independently equal to 0 to 1, and δ is from stoichiometry; and
La₁₋ₓSrₓCo_{1-y}Fe_{y}O_{3-δ}, wherein x and y are independently equal to 0 to 1, and δ is from stoichiometry.

53. The solid oxide fuel cell according to claim 52, wherein the cathode comprises doped ceria.

54. The solid oxide fuel cell according to claim 40, wherein the cathode comprises a combination of materials comprising a metal selected from platinum, silver, gold and mixtures thereof, and an oxide of a rare earth element and a ceramic selected from
La₁₋ₓSrₓMnO_{3-δ}, wherein x and y are independently equal to 0 to 1, and δ is from stoichiometry; and
La₁₋ₓSrₓCo_{1-y}Fe_{y}O_{3-δ}, wherein x and y are independently equal to 0 to 1, and δ is from stoichiometry.

55. The solid oxide fuel cell according to claim 40, wherein the electrolyte membrane is selected from yttria-stabilized zirconia, La₁₋ₓSrₓGa_{1-y}Mg_{y}O_{3-δ} wherein x and y are 0 to 0.7, and δ is from stoichiometry, and doped ceria.

56. A method for producing energy comprising the steps of:
a) feeding at least one fuel into an anode side of a solid oxide fuel cell comprising
an anode comprising a cermet comprising a metallic portion and an electrolyte ceramic material portion, said portions being substantially uniformly interdispersed, said metallic portion having a melting point equal to or lower than 1200° C.; said cermet having a metal content higher than 50 wt %, and a specific surface area equal to or lower than 5 m²/g;
a cathode; and
at least one electrolyte membrane disposed between said anode and said cathode;
b) feeding an oxidant into a cathode side of said solid oxide fuel cell; and
c) oxidizing said at least one fuel in said solid oxide fuel cell, resulting in production of energy.

57. The method according to claim 56, wherein the solid oxide fuel cell operates at a temperature of 400° C. to 800° C.

58. The method according to claim 57, wherein the solid oxide fuel cell operates at a temperature of 500° C. to 700° C.

59. The method according to claim 56, wherein the fuel is hydrogen.

60. A process for preparing a solid oxide fuel cell comprising a cathode, an anode and at least one electrolyte membrane disposed between said anode and said cathode, wherein said anode comprises a cermet including a metallic portion and an electrolyte ceramic material portion; said process comprising the steps of:
providing a cathode;
providing the at least one electrolyte membrane; and
providing an anode
wherein the step of providing the anode comprises the steps of:
a) providing a precursor of the metallic portion, said precursor having a particle size of 0.2 μm to 5 μm;
b) providing the electrolyte ceramic material having a particle size of 1 μm to 10 μm;
c) mixing said precursor and said ceramic material to provide a starting mixture;
d) heating and grinding said starting mixture in the presence of at least one first dispersant;
e) adding at least one binder and at least one second dispersant to the starting mixture from step d) to give a slurry;
f) thermally treating said slurry to provide a pre-cermet; and
g) reducing the pre-cermet to provide the cermet.

61. The process according to claim 60, wherein the slurry resulting from step e) is applied on the electrolyte membrane.

62. The process according to claim 60, wherein the precursor of the metallic portion is an oxide.

63. The process according to claim 62, wherein the oxide is a copper oxide.

64. The process according to claim 62, wherein the oxide is CuO.

65. The process according to claim 60, wherein the precursor has a particle size of 1 to 3 μm.

66. The process according to claim 60, wherein the ceramic material has a particle size of 2 to 5 μm.

67. The process according to claim 60, wherein step d) is carried out more than one time.

68. The process according to claim 60, wherein the at least one first and second dispersants are selected from ethanol and isopropanol.

69. The process according to claim 60, wherein the at least one first dispersant is the same as the at least one second dispersant.

70. The process according to claim 60, wherein the binder is soluble in the at least one second dispersant.

71. The process according to claim 60, wherein the binder is polyvinylbutyral.

72. The process according to claim 60, wherein step f) is carried out at a temperature of 700° C. to 1100° C.

73. The process according to claim 72, wherein step f) is carried out at a temperature of 900° C. to 1000° C.

74. The process according to claim 60, wherein step g) is carried out at a temperature of 300° C. to 800° C.

75. The process according to claim 74, wherein step g) is carried out at a temperature of 400° C. to 600° C.

76. The process according to claim 60, wherein step g) is performed with hydrogen containing from 1 vol. % to 10 vol. % of water.

77. The process according to claim 76, wherein hydrogen contains from 2 vol. % to 5 vol. % of water.

78. A cermet including a metallic portion and an electrolyte ceramic material portion, said portions being substantially uniformly interdispersed, said metallic portion having a melting point equal to or lower than 1200° C.; said cermet having a metal content higher than 50 wt % and a specific surface area equal to or lower than 5 m²/g.
